(19) United States
(12) Patent Application Publication
(10) Pub. No.: US 2007/0081851 A1
(43) Pub. Date: Apr. 12, 2007

(54) Cosmetic case

(76) Inventor: Young-Kwang Byun, Seoul (KR)

Correspondence Address: BIRCH STEWART KOLASCH & BIRCH, PO BOX 747, FALLS CHURCH, VA, 22040-0747, US

(21) Appl. No.: 11/528,426

(22) Filed: Sep. 28, 2006

(30) Foreign Application Priority Data
Oct. 11, 2005 (KR) 10-2005-0095350

(51) Int. Cl. A47L 13/22; B43K 5/06

(52) U.S. Cl. 401/286; 401/175

(57) ABSTRACT

A cosmetics case comprising a cosmetics case having a lower body of the case is turns, and a piston in which is applied in inner portion of the lower body is moved lower to press the inside, with aligned to a screw rod by the turning of the lower body of the container, and thus, a check valve of which installed in upper inside hall which formed upper portion of inside of the screw rod, is pressed open then, opened a through hole, therefore, the liquid cosmetics which stored inside of the lower body is passed through a perpendicular hole, a through hole, an upper inside hole and an liquid transfer tube which formed an ejecting hole, then ejecting the liquid to a brush portion with a determined quantity of the cosmetics; The lower body is stops turning, concurrently with; to lower pressure of the inside of the lower body, and the check valve returned to the origin state by the spring power of the spring which installed inside of the upper inside hole and, close off the through hole, therefore the cosmetics can not ejecting out more; thus can easily control the ejecting and close off the cosmetics liquid.

### CROSS-REFERENCE TO RELATED APPLICATIONS

This application claims the benefit of Korean Patent Application No. 10-2005-0095350, filed on Oct. 11, 2005, in the Korean Intellectual Property Office, the disclosure of which is incorporated herein by reference.

### BACKGROUND

1. Field of the Invention

The present invention relates to a cosmetics case of an ejecting or squeeze type liquid cosmetics such as a foundation or lipsticks, and more particularly, to a cosmetics case having a lower body of the container is turns, and a piston in which applied in inner portion of the lower body is moved lower to press the inside, with aligned to a screw rod by the turning of the lower body of the container, and thus,

a check valve of which installed in upper inside hall which formed upper portion of inside of the screw rod, is pressed open then, opened a through hole, therefore, the liquid cosmetics which stored inside of the lower body is passed through a perpendicular hole,

a through hole, an upper inside hole and a liquid transfer tube which formed an ejecting hole, then ejecting the liquid to a brush portion with a determined quantity of the cosmetics;

The lower body stopped the turning, concurrently with; lowered the pressure of the inside of the lower body, and the check valve returned to the origin state by the spring power of the spring which installed inside of the upper inside hole and, closed the through hole, therefore, the cosmetics can not ejecting more; thus can easily control the ejecting and close off the cosmetics liquid.

2. Discussion of Related Art

Various cosmetics cases have been used to satisfy demands that they should be compact and convenient for use, have an attractive appearance, and be such as to allow the cosmetics contained therein to be easily handled.

Typically, cosmetics are solid and powder or liquid state. Currently, liquid cosmetics of foundation or lipsticks are applied to the convenience of the user. The liquid cosmetics are filled in a pencil type circular container, the cosmetics are ejecting to the upper portion of brush part of the inside of the case by pressing inside of case when turns a part of the container by the user.

Hereinafter, a conventional cosmetics case will be described in detail with reference to the drawings.

An Ejecting type liquid cosmetics case of the prior art, are disclosed in FIG. 6 and FIG. 7.

The container comprised with a case body 101 which received liquid cosmetics, a brush 102 which applied with use and a cap 103 for protect the brush 102. The case body 101 composed with a rod 104 which has a piston 103 that pushing the liquid cosmetics to the brush 102, and a nut element 105a which joined to the rod 104 with a screw joint and fixed to the wall of the body 101 and support the moving of the rod 104, and moving body 105 which having an one direction turning guide element 105b to the nut element 105a and a rod movement cap 106 which circulating the rod 104.

The cosmetics case of the above mentioned prior art, the piston 103 which jointed to the head end of the rod 104, is inserting joined in the coupling portion 104a; and therefore the moving of the piston 103 is severe from the rod 104, and easily separated from an small impact. An end of the spring 107 which applying repulsive power to a rod moving cap 106 that inserted to the rear end of the rod 104.

When, the rod moving cap 106 is moving rotate, an end of the spring 107 is interfered with the rod moving cap 106, then, arise a noise and the revolution of the rod moving cap 106 is not smoothly.

And since the moving body 105 which having an one direction turning guide element 105b to the nut element 105a and the nut element, can rotate to one direction only and returning is not available, and so that can not prevent flue of the cosmetics flow when has a small impact or positioned reversely. Therefore, many disadvantages are occurred. And it is complicated in construction and costs much.

### SUMMARY OF THE INVENTION

Accordingly, it is an object of the present invention to provide a reasonable cosmetics case to accomplish good result in convenience in use and commercial.

In order to achieve the foregoing and/or other objects of the present invention, according to the present invention, there is provided a cosmetics case comprising a cosmetics case 1 having a lower body 10 of the container is turns, and a piston in which is applied in inner portion of the lower body is moved lower to press the inside, with aligned to a screw rod by the turning of the lower case body,

and thus, a check valve of which installed in upper inside hall which formed upper portion of inside of the screw rod, is pressed open then, opened a through hole 32, therefore, the liquid cosmetics 3 which stored inside of the lower body is passed through a perpendicular hole 33, a through hole 32, an upper inside hole and an liquid transfer tube which formed an ejecting hole, then ejecting the liquid to a brush portion 50 with a determined quantity of the cosmetics;

The lower body is stops turning, concurrently with; to lower pressure of the inside of the lower body, and the check valve returned to the origin state by the spring power of the spring which installed inside of the upper inside hole and, close off the through hole 32, therefore the cosmetics can not ejecting out more; thus can easily control the ejecting and close off the cosmetics liquid.

### BRIEF DESCRIPTION OF THE DRAWINGS

These and/or other objects and advantages of the invention will become apparent and more readily appreciated from the following description of the preferred embodiments, taken in conjunction with the accompanying drawings of which:

FIG. 1 is a schematic perspective view in accordance with one embodiment of the present invention.

FIG. 2 is a separated perspective view in accordance with one embodiment of the present invention.

FIG. 3 is a combined cross sectional view in accordance with one embodiment of the present invention.

FIG. 4 is an use state view in accordance with one embodiment of the present invention, it shows stored cosmetics in the lower body are vanishing completely by the piston go down;

FIG. 5 is an enlarged cross sectional view of portion A of FIG. 4;

FIG. 6 is a front view of a case of a conventional ejecting type liquid cosmetics in prior art; and

FIG. 7 is a separated perspective view of a conventional ejecting type liquid cosmetics in prior art;

### DETAILED DESCRIPTION OF PREFERRED EMBODIMENTS

Hereinafter, a preferred embodiment of the present invention will be described with reference to the attached drawings.

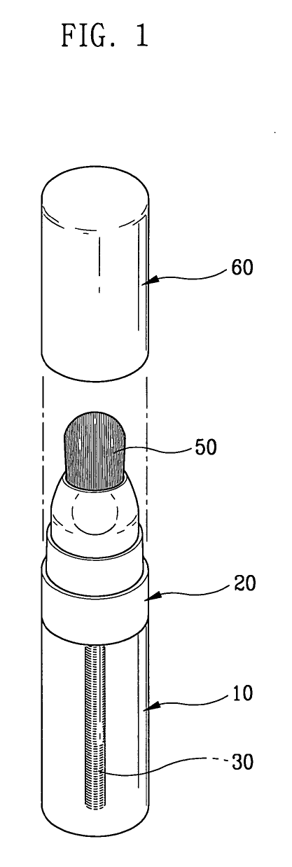

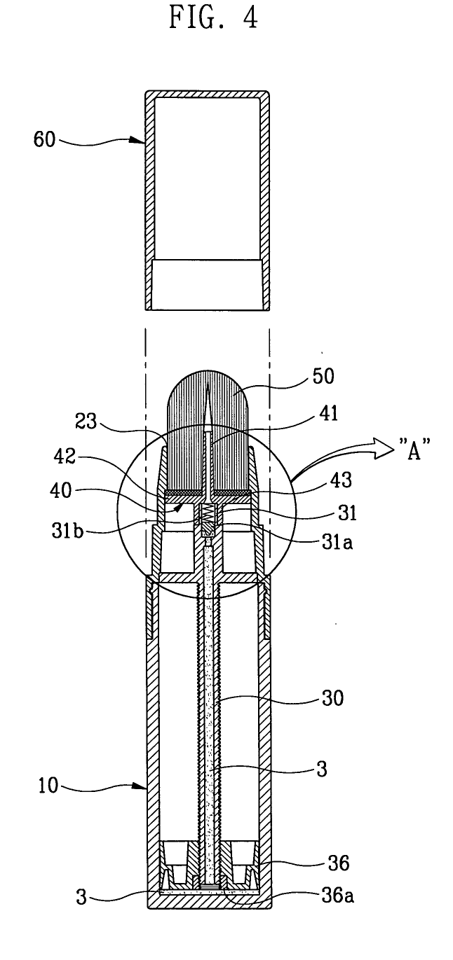

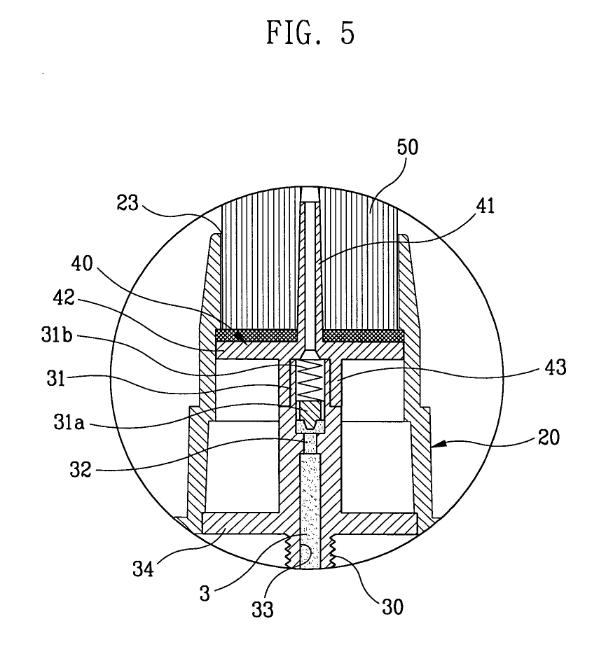

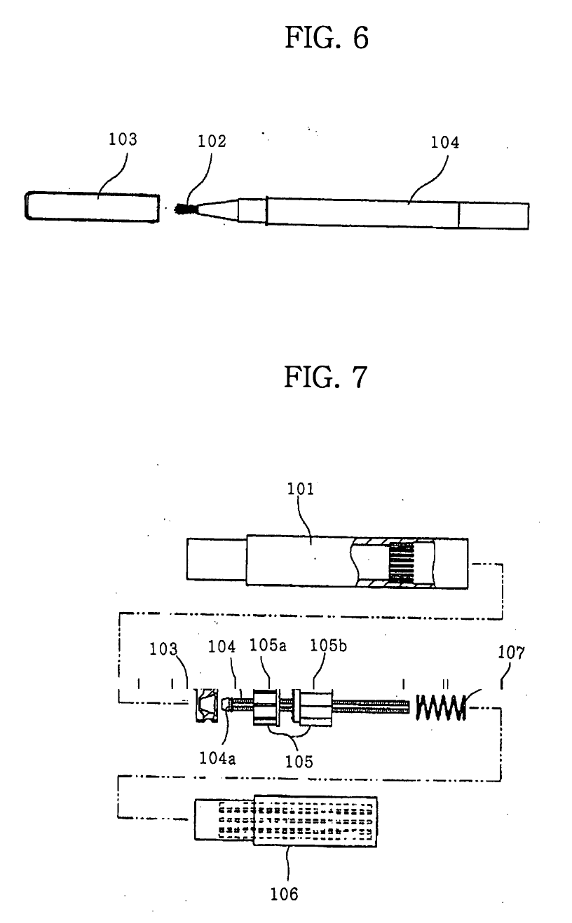

As illustrated in FIG. 1-FIG. 5, a cosmetics case comprising a cosmetics case 1 having a lower body 10. a piston 36 in which applied in inner portion of the lower body, is go down to press the inside, with aligned to a screw rod 30 by the

turning of the lower body 10 of the container, and thus, a check valve 31a which installed in upper inside hall 31 formed on the upper portion of inside of the screw rod 30, is pressed to open Then, open a through hole 32, therefore, the liquid cosmetics 3 which stored on inside of the lower body 10 is passed through a perpendicular hole 33, a through hole 32, an upper inside hole 31 and an liquid transfer tube 41 which formed an ejecting hole 40, then ejecting the liquid to a brush portion 50 with a determined quantity of the cosmetics;

The lower body 10 is stops from the turning, concurrently with; to lower the pressure of the inside of the lower body 10,

and the check valve 31a returned to the original state by the spring power of the spring 31b which insert installed inside of the upper inside hole 31 and, close off the through hole 32, therefore the cosmetics 3 can not ejecting out more;

Thus, can easily control the ejection and close off the cosmetics liquid by the opening and shutting of the through hole 32 with pressed to the check valve 31a, while drop down of the piston 36 aligned with the screw rod 30 with the rotation of the lower body 10.

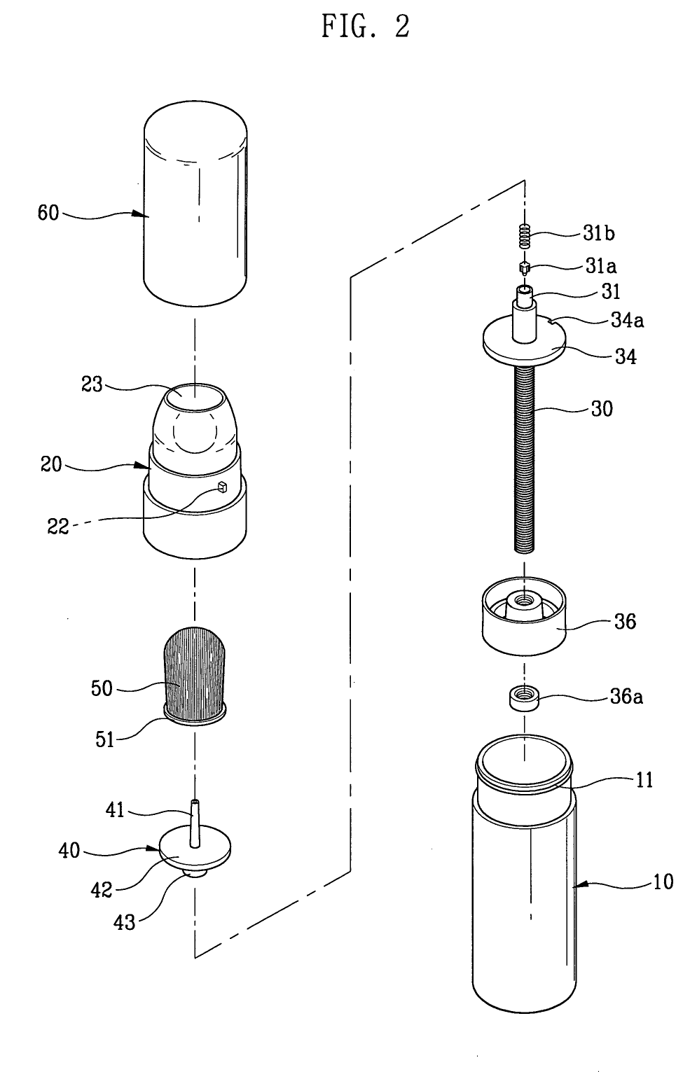

As shows in FIG. 2-FIG. 4; the construction of the cosmetics case includes a lower body 10 which formed a cylinder type and stored the cosmetics liquid there in, an upper body 20 is insertion jointed on the upper portion of the lower body; a screw rod 30 having a piston 36 is installed in the inside of said upper body 20 and lower body 10, with coupled with a brush 50 and ejecting hole 40; and a cap 60 is coupled on the upper portion of the upper body 20.

The said lower body 10 has a cup configuration of which lower portion is closed and opened on the top, and having a cylinder function and store the cosmetics liquid 30 therein. And an outward ring type protrude ring 11 is formed on the upper outside peripheral surface of the lower body in freely rotation with a position of a constant state without separation of the upper body 20 in the time of coupling of the upper body 20.

And, an inward ring 21, of which jointed with the outward ring type protrude ring 11 of said lower body 10,

is formed on the bottom inside peripheral surface of the upper body 20 which joined with the lower body 10, a protrude portion 22, is formed on upper portion of adjacent to the inward ring 21, which fixed with inserted with a groove 34a which formed on the peripherals of a screw fixed plate 34, and an opening portion 23 formed on the upper portion, as herein after described.

A brush 50 is fixed on the upper portion of a brush plate 51 on the top of the ejecting hole 40 in the inside of upper body 20 and installed in exposed to the opening 23.

A liquid transfer tube 41 is formed on upper portion of the supporting plate 42 in which formed as a disk and an insertion portion 44 is formed on the lower portion on the ejecting hole 40.

A screw rod 30 is insertion jointed to the bottom of the ejecting hole 40, an upper inside hole 31 formed on the top of the screw rod 30, a through hole 32 and a perpendicular hole 33 are formed on the bottom of the inside hole. 31 and,

connected to the inside of the screw rod 30, a screw fitting plate 34 is formed outside peripheral of an upper suitable position of said screw rod 30, in integration and, a piston 36 is fitted with nuts on the peripheral of the lower screw rod 30 thus, positioned on the bottom of the screw fitting plate 34.

An o-ring 36a is inserting fitted on the inside of lower portion of the piston 36 to maintain a closed tightness by a nut fitting on the screw rod 30.

The spring 31b and the check valve 31a are inserting fitted on the inside of the inside hole 31 formed on the top of the screw rod 30 and prevent a flue of cosmetics liquid 3 when non use the cosmetics liquid 3 and the top end of the screw rod 30 which formed the upper inside hole 31, is insertion jointed to the insertion part 43 which formed on the bottom of the ejecting hole 40.

The lower body 10 is inserting jointed to the bottom of the upper body 20 in which having the brush 50, the ejecting hole 40 and the screw rod 30, and the piston 36, which has nut jointed to the peripheral of the screw rod 30 is inserting coupled with a strong tightness to the inside of the lower body 10.

Now, the action of the present invention in use in a preferred embodiment of the present invention will be described.

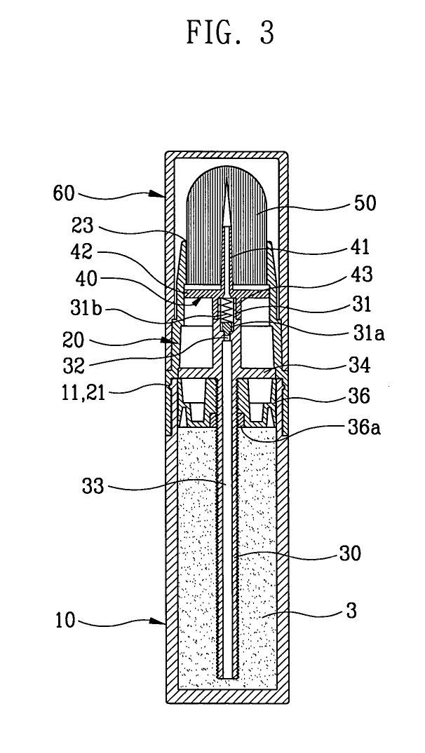

The present invention is assembled as FIG. 3 in initially with which; a suitable quantity of cosmetics liquid 3 are filled in the

lower body 10, the brush 50, ejecting hole 40 and the screw rod 30 are inserted to the inward ring 21 of the upper body 20 and coupled to the outward protrude ring 11 formed on the lower body 10, thus, lower body 10 and the upper body 20 are jointed in integrally and available to rotate in integrally. Furthermore, the piston 36 is insertion jointed to the bottom of the screw rod 30. The screw fitting plate 34 which formed on the suitable position of the upper portion of the screw rod 30, is fixed to a protrude portion 22 of the upper body 20 by the insertion of the groove 34a, thus, the position is fixed to the state of suppress to rotate.

Then, in case of use the cosmetics liquid, the user opened the cap 80 and take hold the upper body 20 with one hand and

hold lower body 10 with another hand and turn to the one direction, the piston 36 is rotated with the lower body 10; thus, the piston 36 moved upwardly with a rotation, with the lower body 10 along to the line of the screw on the screw rod 30. That is, the inside of the piston 36 is coupled with the screw rod 30, and the outside peripherals are adjacent to the inside peripherals of the lower body 10 and thus, when the lower body 10 is rotating along with the piston 36, so that, the piston 36 moves along with the lane of screw of the screw rod 30.

Since, the lower direction movement of the piston 36 is pressurized up the pressure of the inside of the lower body 10 which filled with the cosmetics liquid 3, so as, the check valve 31a is pushed by the spring 31b of which insertion installed

on the upper inside hole 31 of the screw rod 30, concurrently with thus, the through hole 32 is opened and the cosmetics liquid 3 in the inside of the lower body 10 are pass through the perpendicular hole 33, through hole 32 and upper inside hole 31 and should be eject to the brush 50 of which inserting fixed on the upper portion of liquid transfer tube 41.

Therefore, the user can use the cosmetics liquid 3 on the side of the brush 50 that ejected from the inside of lower body 10 as along with the revolution degree of the lower body 10.

When, the user stopped the revolution of the lower body 10 after ejecting of the cosmetics liquids 3 on the brush 50 then, the pressure of inside of the lower body 10 is to be weakened and return the check valve 31a with the spring 31b which installed in the upper inside hole 31 of the screw rod 30 and closed the through hole 32 thus, prevent the ejection of cosmetics liquid 3.

The cosmetics case according to the present invention is ejecting the cosmetics liquid 3 only with the revolution of the lower body 10 therefore, and never eject when stopped the turning.

While, when, the user hold the turns of the lower body 10 exceedingly and too much quantity of the cosmetics liquid 3 are ejected, the piston 36, in which jointed to the screw rod 30, may turns to the reverse direction to evacuate in the inner portion of the inside of the lower body 10, by the returning of the lower body 10 to the reverse direction, thus the check valve 31a is draw back to closed the through hole 32, thus prevent to ejecting of the cosmetics liquid 3.

As described above, according to the present invention, is possible opening and closing for a suitable quantity of the cosmetics liquid 3 to use. And prevent the loss ejecting by the check valve 31a from the change of the temperature or inside pressure of the lower body 10 to expansion.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. In a cosmetics case comprising; a lower body 10 and an upper body 20 are jointed together and, a cap 60 is jointed on the upper portion of the upper body, with which comprising;
the brush 50 is formed with exposed to inside opening of the upper body, an ejecting hole 40 having the liquid transfer tube and the insertion part 43 is insertion jointed to the bottom of the brush, a piston 36 is jointed with nut to the insertion part of which formed on to the ejecting hole 40 with insertion jointed the upper portion of the screw rod 30, the screw rod 30 is insert fitted to the lower body 10.

2. The cosmetics case of claim 1, wherein the upper inside hole 31 is formed on the top of the screw rod 30, the through hole 32 and the perpendicular hole 33 are formed with pass through on the inside bottom of the upper inside hole 31, the piston 36 is coupled to the peripheral portion of the upper inside hole 31, the piston 38 go down with revolution of said lower body 10 and the cosmetics liquid 3 in the inside of the lower body 10 are pass through the perpendicular hole 33, through hole 32 and upper inside hole 31.

3. The cosmetics case of claim 1, wherein a spring 31b and check valve 31a are insertion installed to the inside of the upper onside hole 31 which formed on the screw rod 30.
